(19) United States
(12) Patent Application Publication
(10) Pub. No.: US 2012/0236139 A1
(43) Pub. Date: Sep. 20, 2012

(54) DESTRUCTIVE WEB THICKNESS MEASURING SYSTEM OF MICRODRILLS AND METHOD THEREOF

(76) Inventors: Wen-Tung Chang, Taipei City (TW); Shui-Fa Chuang, Kaohsiung County (TW); Yi-Shan Tsai, Taipei County (TW); Geo-Ry Tang, Taipei City (TW); Fang-Jung Shiou, Taipei City (TW)

(21) Appl. No.: 13/046,910

(22) Filed: Mar. 14, 2011

(51) Int. Cl. H04N 7/18

(52) U.S. Cl. 348/88; 348/E07.085

(57) ABSTRACT

A destructive web thickness measuring system of microdrills includes a computer device, a dual-axis motion platform module, a drill grinding module, a positioning vision module, and a web thickness measuring vision module. When the computer device controls the dual-axis motion platform module to move a microdrill to a first locating position, the computer device performs a positioning procedure according to a first image captured by the positioning vision module, and then performs a grinding procedure, so that the drill grinding module grinds the microdrill to a sectional position to be inspected. When the ground microdrill moves to an image measuring position, the computer device performs an image computing procedure according to a second image captured by the web thickness measuring vision module, so as to obtain a web thickness value. Therefore, the destructive web thickness measuring system of microdrills can automatically measure the web thickness value.

### FIELD OF INVENTION

The present invention relates to a destructive web thickness measuring system of microdrills and a method thereof, and more particularly to an automated destructive web thickness measuring system of microdrills and a method thereof.

### RELATED ART

Microdrills have been widely applied in microhole drilling of various printed circuit boards. FIGS. 1A, 1B, and 1C are respectively a side schematic structural view of a microdrill according to an embodiment, a schematic structural view of a radial section 1B-1B according to FIG. 1A, and a schematic view of an axial section 1C-1C according to FIG. 1A. A microdrill 50 includes a central axis 51, a shank 52, and a drill body 54, wherein the drill body 54 includes a drill point 60, a helical flute 58, and a drill tip 60a. The drill body 54 is magnified in scale relative to the shank 52 for ease of illustration. The drill body 54 is composed of the drill point 60 and the helical flute 58 in function. The drill point 60 is used for producing a drilling action, and the helical flute 58 is used for removing chips. A conical core portion that is not fluted in the drill body 54 is a web 56, and in the design, a thickness of the web 56 (referred to as a web thickness 62 for short below) and a depth of the helical flute 58 conflict with each other. The microdrill 50 with a greater web thickness 62 can lead to good drill rigidity while the depth of the helical flute 58 is smaller, thus resulting in a poor chip-removing effect. On the contrary, the helical flute 58 with a greater depth can lead to a good chip-removing effect while the drill rigidity thereof is lower. Therefore, the web thickness is a key parameter influencing quality of the microdrill. The measurement of the web thickness value of microdrill products for improving manufacturing parameters is an important quality management task that microdrill manufacturers concern.

The web thickness measuring methods of microdrills can be divided into two types in general: a non-destructive type and a destructive type. In the Taiwan Patent Publication No. 1254124, a non-destructive measuring technology for a web thickness value based on the use of a laser micro-gauge (LMG) and a laser confocal displacement meter (LCDM) is provided. However, in practice, the non-destructive measuring technology for the web thickness value still has problems such as a high cost and insufficient stability, which fails to facilitate the development of the non-destructive measuring technology for the web thickness value. In view of the above problems, industries in the art still adopt a destructive measuring technology for the web thickness value. In a conventional destructive measuring procedure for the web thickness value, a microdrill grinder is used to destructively grind a drill body of a microdrill to a sectional position to be inspected of a certain axial section. Next, an experienced inspector measures a web thickness of the ground axial section by using a measuring microscope. The inspector obtains the web thickness value according to a minimum distance measured between two flute contours observed at the ground axial section. Since the above process is manually operated, the problems that it requires long time and it is difficult to ensure accuracy of an inspected position and precision of a web thickness value exist.

### SUMMARY OF THE INVENTION

In view of the above problems, the present invention is directed to a destructive web thickness measuring system of microdrills and a method thereof, so as to solve the problem in the prior art that requires long time to perform manual measurement and is difficult to ensure accuracy of an inspected position and precision of a web thickness value.

The destructive web thickness measuring system of microdrills according to the present invention is suitable for measuring a web thickness value of a microdrill. In an embodiment, a destructive web thickness measuring system of microdrills comprises a computer device, a dual-axis motion platform module, a drill grinding module, a positioning vision module, and a web thickness measuring vision module. The dual-axis motion platform module is coupled to the computer device. The dual-axis motion platform module is used for holding the microdrill, and the computer device controls the dual-axis motion platform module to enable the microdrill to move. When the computer device controls the dual-axis motion platform to move the microdrill to a grinding position, the drill grinding module grinds a drill body of the microdrill to a sectional position to be inspected.

When the computer device controls the dual-axis motion platform module to move the microdrill to a first locating position, the positioning vision module captures and outputs a first image to the computer device, and the computer device performs a positioning procedure according to the first image to obtain a first distance between the microdrill and the drill grinding module. The computer device controls the dual-axis motion platform module and the drill grinding module according to the first distance and the sectional position to be inspected, so that the drill grinding module grinds the microdrill to the sectional position to be inspected. The first locating position is in a first image capture range of the positioning vision module, and the microdrill does not contact with the drill grinding module. When the computer device controls the dual-axis motion platform module to move the microdrill to an image measuring position, the web thickness measuring vision module captures and outputs a second image to the computer device, and the computer device performs an image computing procedure according to the second image to obtain the web thickness value of the microdrill at the sectional position to be inspected. The image measuring position is in a second image capture range of the web thickness measuring vision module.

According to an embodiment of a destructive web thickness measuring method of microdrills disclosed in the present invention, the destructive web thickness measuring method of microdrills comprises: moving a dual-axis motion platform module to an origin position; setting a sectional position to be inspected of the microdrill according to a position parameter; moving the microdrill to a first locating position by the dual-axis motion platform module, wherein the first locating position is in a first image capture range of a positioning vision module, and the microdrill does not contact with a drill grinding module; performing a positioning procedure according to the first image to obtain a first distance between the microdrill and the drill grinding module; performing a grinding procedure according to the first distance and the sectional position to be inspected, so that the drill grinding module grinds the microdrill to the sectional position to be inspected; moving the microdrill to an image measuring position by the dual-axis motion platform module, wherein the image measuring position is in a second image capture range of a web thickness measuring vision module; capturing a second image by the web thickness measuring vision module; and performing an image computing procedure according to the second image to obtain a web thickness value of the microdrill at the sectional position to be inspected.

The destructive web thickness measuring system of microdrills and the destructive web thickness measuring method of microdrills according to the present invention can be used for automatically measuring the web thickness value of the microdrill at the sectional position to be inspected. By the design of the positioning vision module, it can be effective to ensure whether the drill grinding module grinds the microdrill to the sectional position to be inspected in the positioning procedure and the grinding procedure. By the design of the web thickness measuring vision module and the image computing procedure, the measuring stability of the destructive web thickness measuring system of microdrills according to the present invention can be improved. By the setting of the computer device, the process of the destructive web thickness measurement of the microdrill can be effectively controlled.

### BRIEF DESCRIPTION OF THE DRAWINGS

FIG. 1A is a side schematic structural view of a microdrill according to an embodiment;

FIG. 1B is a schematic structural view of a section 1B-1B according to FIG. 1A;

FIG. 1C is a schematic structural view of a section 1C-1C according to FIG. 1A;

FIG. 2A is a schematic structural block diagram of a destructive web thickness measuring system of microdrills according to an embodiment of the present invention;

FIG. 2B is a three-dimensional schematic structural view of a dual-axis motion platform module, a drill grinding module, a positioning vision module, and a web thickness measuring vision module according to an embodiment of the present invention;

FIG. 2C is a top schematic structural view of a dual-axis motion platform module, a drill grinding module, a positioning vision module, and a web thickness measuring vision module according to an embodiment of the present invention;

FIG. 2D is a magnified schematic structural view of a drill fixture and a microdrill according to FIG. 2C;

FIG. 2E is a top schematic structural view of a microdrill at an image measuring position according to FIG. 2C;

FIG. 3 is a schematic flow chart of a destructive web thickness measuring method of microdrills applied in a destructive web thickness measuring system of the microdrill in FIG. 2A according to an embodiment;

FIG. 4 is a schematic flow chart of a positioning procedure in Step 310 according to an embodiment;

FIG. 5A is a schematic view of a first image in Step 308 according to an embodiment of the present invention;

FIG. 5B is a schematic structural view of Step 404 according to an embodiment of the present invention;

FIG. 5C is a schematic structural view of a microdrill being moved to a first locating position according to an embodiment of the present invention;

FIG. 5D is a schematic structural view of a grinding wheel grinding a microdrill to a sectional position to be inspected according to an embodiment of the present invention;

FIG. 6 is a schematic flow chart of a grinding procedure in Step 312 according to an embodiment;

FIG. 7A is a schematic view of a second image in Step 316 according to an embodiment of the present invention;

FIGS. 7B to 7I are a schematic flow chart of an image computing procedure in Step 318 according to an embodiment;

FIG. 8 is a flow chart of steps of an image calibration procedure before Step 304 in FIG. 3 according to an embodiment; and

FIG. 9 is a schematic flow chart of a destructive web thickness measuring method of microdrills applied in a destructive web thickness measuring system of microdrills in FIG. 2A according to another embodiment.

### DETAILED DESCRIPTION OF THE INVENTION

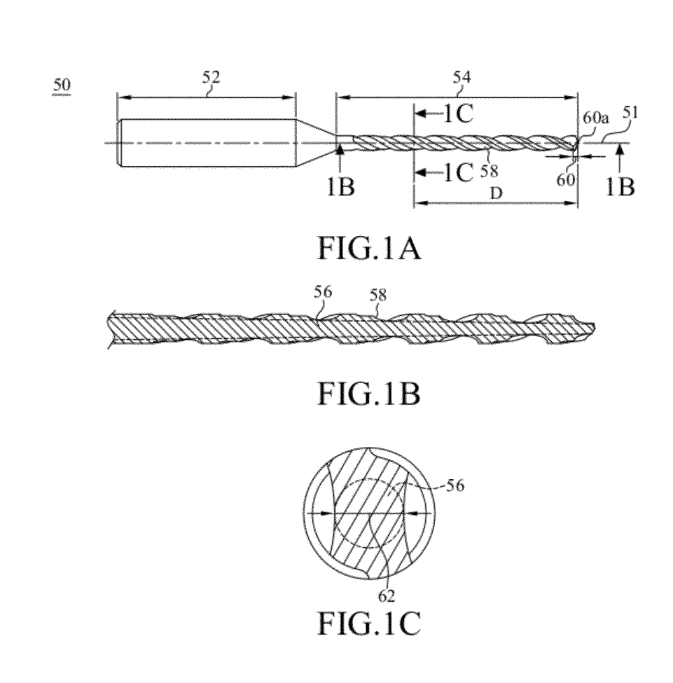

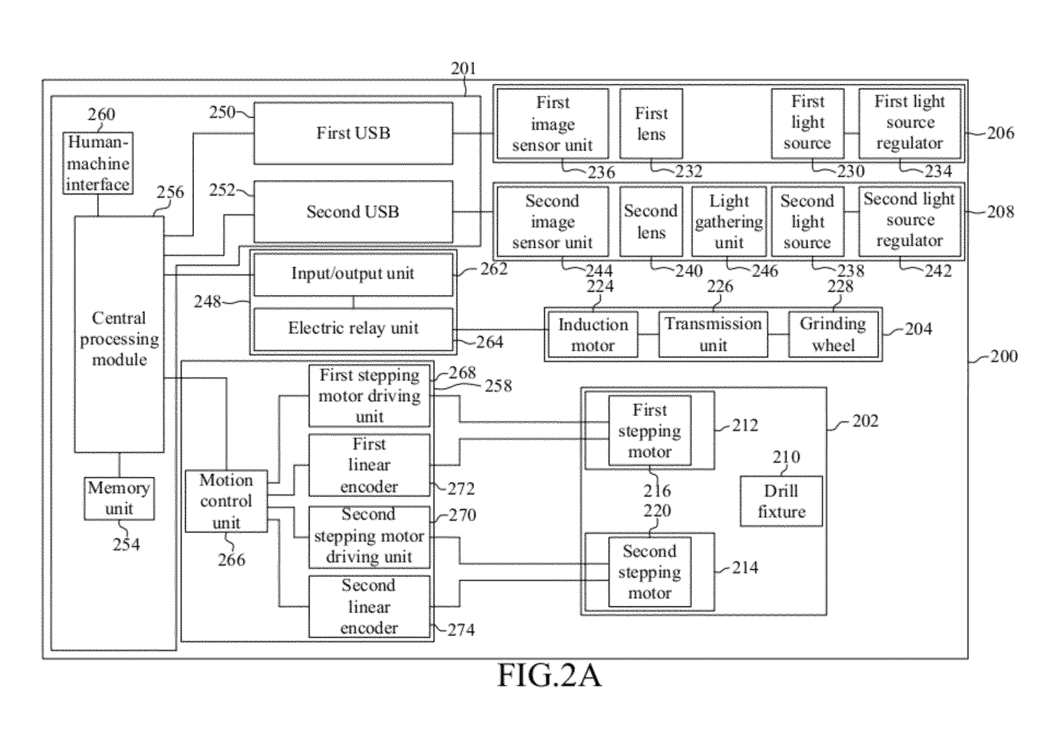

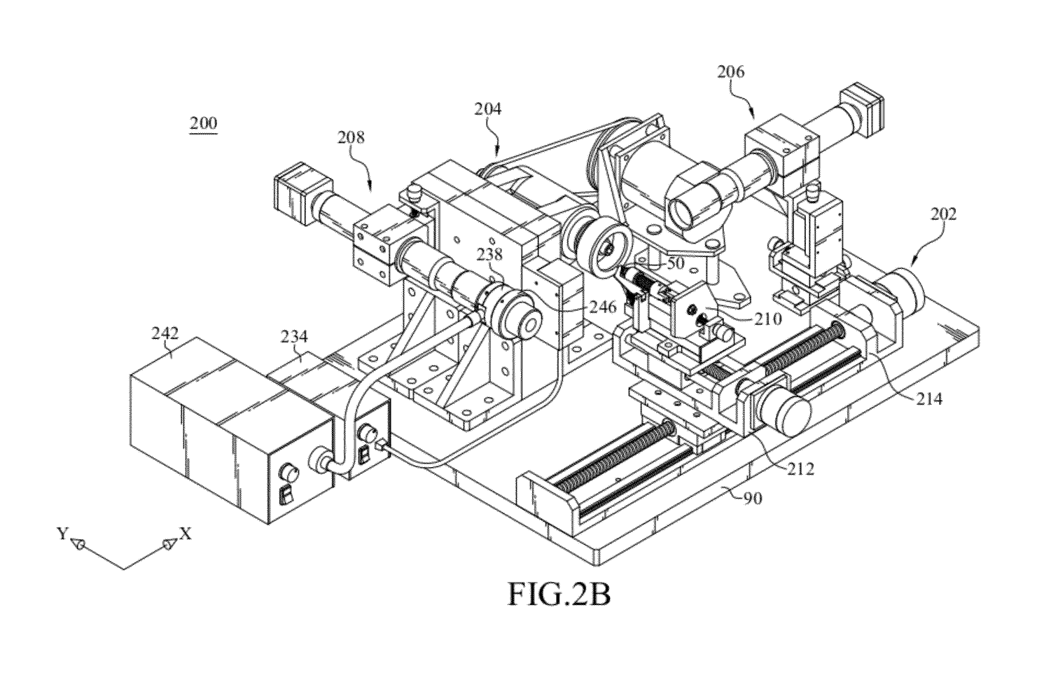

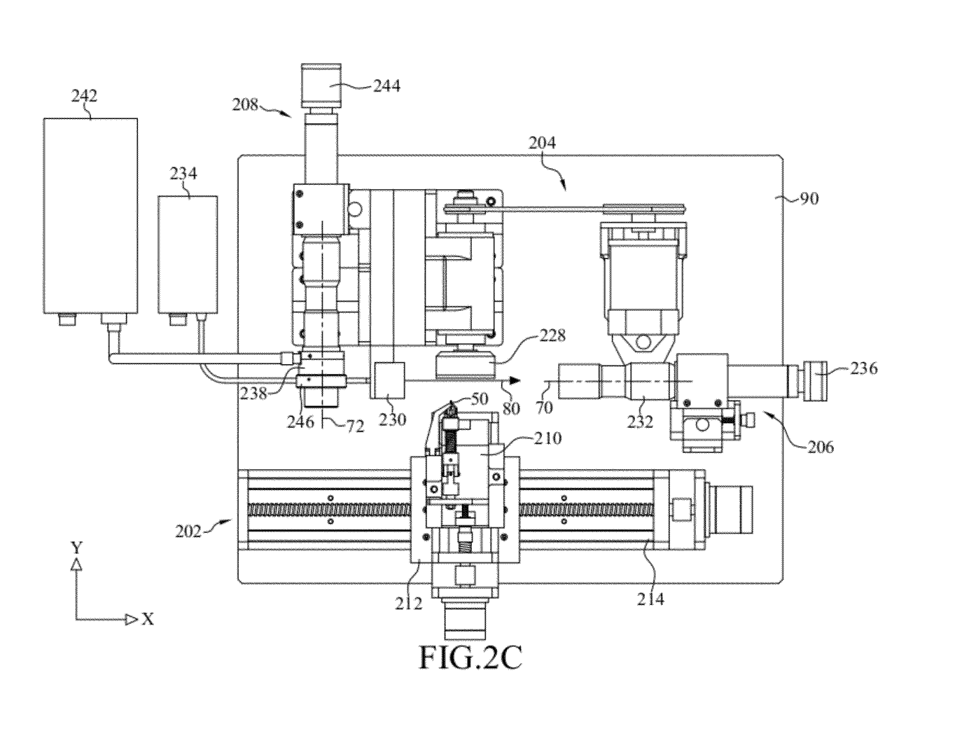

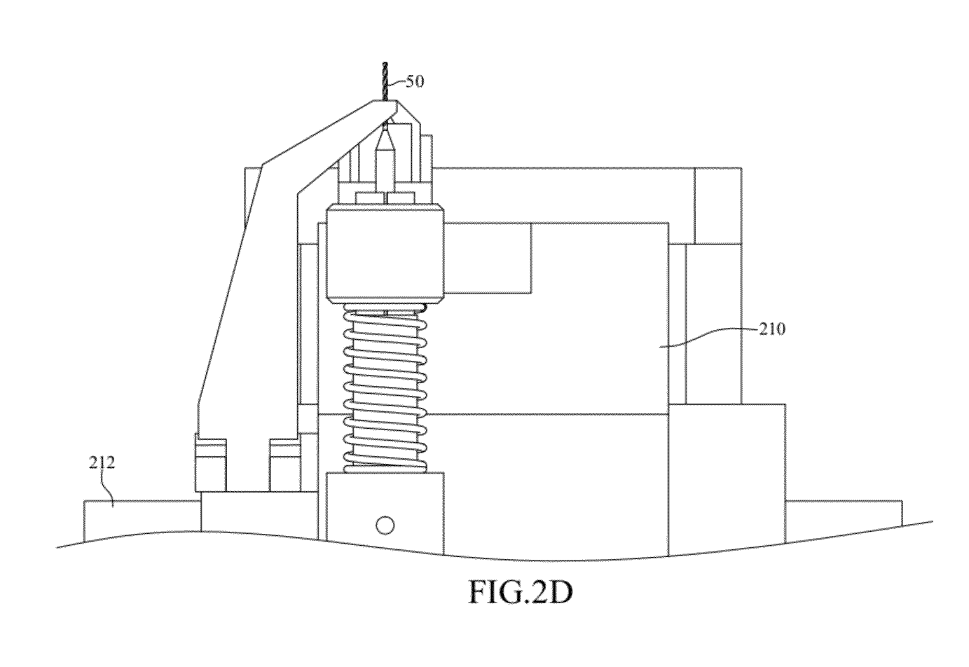

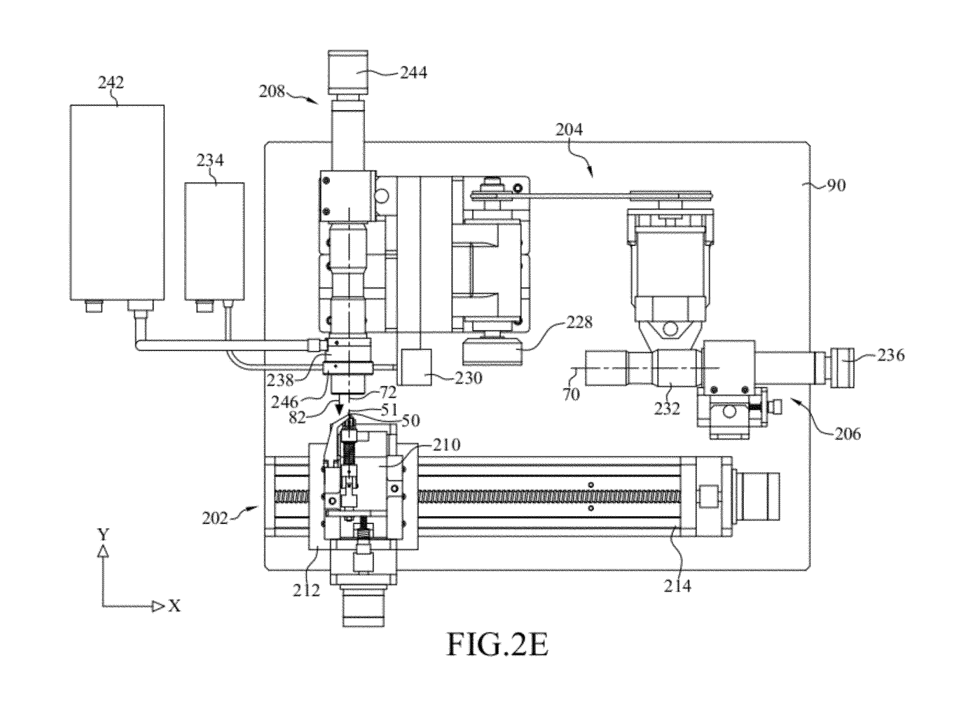

FIGS. 2A, 2B, and 2C are respectively a schematic structural block diagram of a destructive web thickness measuring system of microdrills according to an embodiment of the present invention, a three-dimensional schematic structural view and a top schematic structural view of a dual-axis motion platform module, a drill grinding module, a positioning vision module, and a web thickness measuring vision module according to an embodiment of the present invention. In this embodiment, a destructive web thickness measuring system of microdrills 200 is suitable for measuring a web thickness 62 of a microdrill 50 at a sectional position to be inspected D (referring to FIGS. 1A and 1C). The destructive web thickness measuring system of microdrills 200 comprises a computer device 201, a dual-axis motion platform module 202, a drill grinding module 204, a positioning vision module 206, a web thickness measuring vision module 208, a grinding wheel switch submodule 248, and a motion control submodule 258. The dual-axis motion platform module 202, the drill grinding module 204, the positioning vision module 206, and the web thickness measuring vision module 208 are all disposed on a base 90. The dual-axis motion platform module 202 and the motion control submodule 258 are coupled to each other, and the motion control submodule 258 is attached to the dual-axis motion platform module 202. The drill grinding module 204 is coupled to the grinding wheel switch submodule 248, and the grinding wheel switch submodule 248 is attached to the drill grinding module 204. The positioning vision module 206, the web thickness measuring vision module 208, the grinding wheel switch submodule 248, and the motion control submodule 258 are respectively coupled to the computer device 201. The computer device 201 may be, but not limited to, a desktop computer or a notebook computer. The grinding wheel switch submodule 248 may comprise an input/output unit 262 and a relay unit 264. The motion control submodule 258 may comprise a motion control unit 266, a first stepping motor driving unit 268, a second stepping motor driving unit 270, a first linear encoder 272, and a second linear encoder 274.

In this embodiment, the dual-axis motion platform module 202 can move the microdrill 50 along a longitudinal direction Y or a transversal direction X, wherein the longitudinal direction Y and the transversal direction X are perpendicular to each other. The dual-axis motion platform module 202 may comprise a drill fixture 210, a longitudinal motion unit 212, and a transversal motion unit 214. The drill fixture 210 is used for holding the microdrill 50 (referring to FIG. 2D, which is a magnified schematic structural view of a drill fixture and a microdrill according to FIG. 2C). The longitudinal motion unit 212 comprises a first stepping motor 216, and the longitudinal motion unit 212 is used for enabling the drill fixture 210 to move along the longitudinal direction Y. The transversal motion unit 214 comprises a second stepping motor 220, and the transversal motion unit 214 is used for enabling the drill fixture 210 to move along the transversal direction X. The drill grinding module 204 is used for grinding the microdrill 50 to the sectional position to be inspected D. The drill grinding module 204 may comprise an induction motor 224, a transmission unit 226, and a grinding wheel 228. The induction motor 224 may drive the grinding wheel 228 to rotate by the transmission unit 226, so as to grind the microdrill 50 to the sectional position to be inspected D. However, the embodiment is not intended to limit the present invention, in other words, the drill grinding module 204 may further comprise a dust gathering unit (not shown) to gather dust generated when the drill grinding module 204 grinds the microdrill 50, so as to prevent the dust from affecting image capturing of the positioning vision module 206.

The positioning vision module 206 is used for capturing a first image of the microdrill 50 at a first locating position (in other words, the first locating position is in a first image capture range of the positioning vision module 206, and the microdrill 50 does not contact with the drill grinding module 204). The positioning vision module 206 may comprise a first light source 230, a first lens 232, a first light source regulator 234, and a first image sensor unit 236. The first light source 230 emits a first light 80. The first light source regulator 234 is used for regulating the brightness of the first light 80. An emitting direction of the first light 80 and a first axial direction 70 of the first lens 232 are actually parallel to the transversal direction X, respectively. The first image sensor unit 236 may receive the first light 80 passing though the first lens 232 and output a first image. The first image sensor unit 236 may be, but not limited to, a complementary metal-oxide-semiconductor (CMOS) camera. That is to say, the first image sensor unit 236 may also be a charge coupled device (CCD) camera.

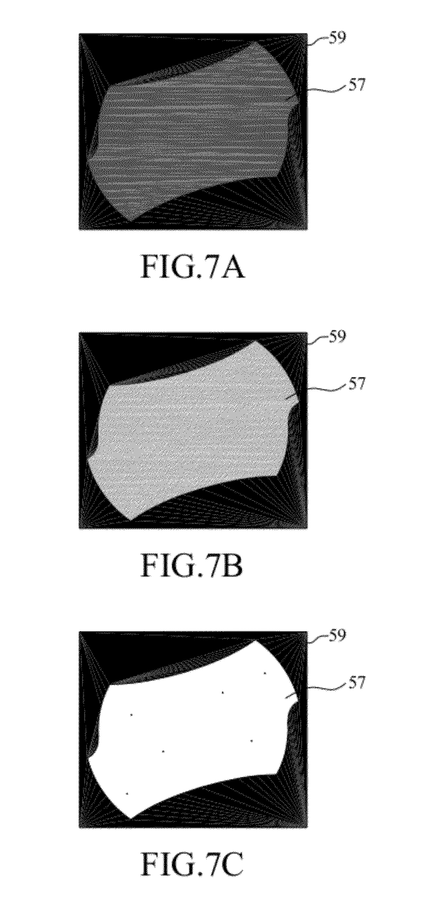

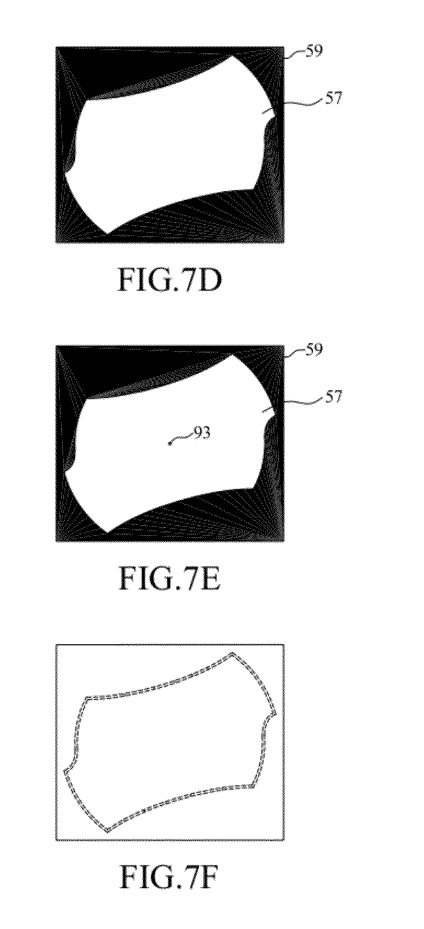

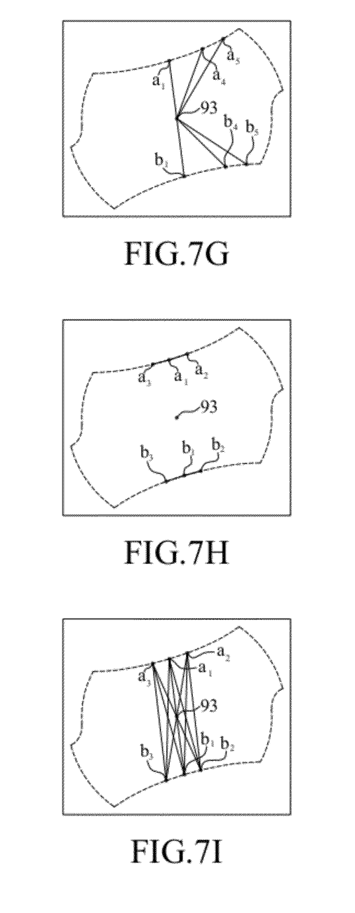

The web thickness measuring vision module 208 is used for capturing a second image of the microdrill 50 at an image measuring position (in other words, the image measuring position is in a second image capture range of the web thickness measuring vision module 208). The web thickness measuring vision module 208 may comprise a second light source 238, a second lens 240, a second light source regulator 242, and a second image sensor unit 244. The second light source 238 emits a second light 82. The second light source regulator 242 is used for regulating the brightness of the second light 82. The second light 82 illuminates an axial section 57 to be inspected of the microdrill 50 (referring to FIG. 7A). Meanwhile, a reflected light formed when the second light 82 illuminates the axial section 57 to be inspected of the microdrill 50 passes through the second lens 240 and then is received by the second image sensor unit 244 which outputs a second image. A second axial direction 72 of the second lens 240 may be parallel to a central axis 51 of the microdrill 50, so as to avoid errors. In this embodiment, the second axial direction 72 may be, but not limited to, in coincidence with the central axis 51 of the microdrill 50 (referring to FIG. 2E, which is a top schematic structural view of a microdrill at an image measuring position according to FIG. 2C).

In addition, the web thickness measuring vision module 208 may further comprise a light gathering unit 246, and the light gathering unit 246 may enable the second light 82 to actually preferably converge at the image measuring position, so as to increase the brightness of the second image captured by the second image sensor unit 244. The second image sensor unit 244 may be, but not limited to, a CCD camera. That is to say, the second image sensor unit 244 may also be a CMOS camera.

The computer device 201 comprises a first universal serial bus (USB) 250, a second USB 252, a memory unit 254, a central processing module 256, and a human-machine interface 260. The computer device 201 may control the induction motor 224 with the input/output unit 262 and the relay unit 264, so as to switch on/off the drill grinding module 204. The first USB 250 and the second USB 252 are respectively coupled to the first image sensor unit 236 and the second image sensor unit 244, so that the computer device 201 may receive the first image and the second image. The memory unit 254 may be used for storing the first image and the second image, and the central processing module 256 may be used for controlling and processing the destructive web thickness measuring process of the microdrill. The computer device 201 may command the first stepping motor driving unit 268 and the second stepping motor driving unit 270 by the motion control unit 266, so as to drive the first stepping motor 216 and the second stepping motor 220 to operate (that is to say, the longitudinal motion unit 212 moves along the longitudinal direction Y, and the transversal motion unit 214 moves along the transversal direction X). The first linear encoder 272 detects and returns a position of the longitudinal motion unit 212 to the motion control unit 266, so as to perform a close loop motion control of the longitudinal direction Y (that is, the first linear encoder 272 control a displacement distance of the longitudinal motion unit 212). The second linear encoder 274 detects and returns a position of the transversal motion unit 214 to the motion control unit 266, so as to perform a close loop control of the transversal direction X (that is, the second linear encoder 274 control a displacement distance of the transversal motion unit 214). The human-machine interface 260 on one hand can be used for receiving a position parameter and measurement relevant setting values input by a user, so that the destructive web thickness measuring system of the microdrill 200 can be adjusted according to practical measuring requirements, and on the other hand can be used for displaying the process performed by the destructive web thickness measuring system of microdrills 200, the first image, and the second image.

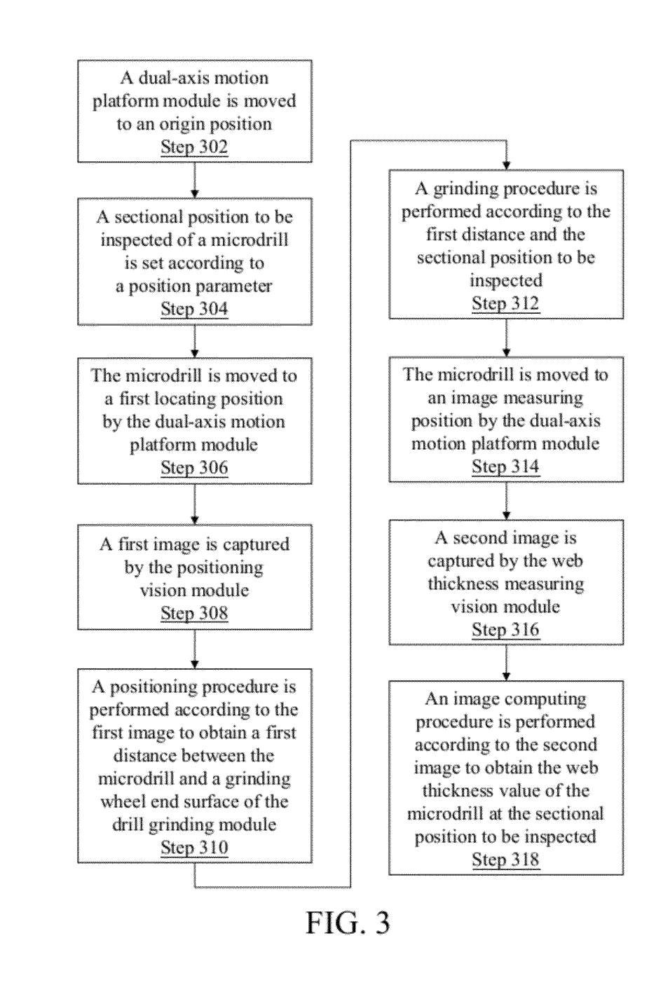

Referring to FIGS. 2A and 3, FIG. 3 is a schematic flow chart of a destructive web thickness measuring method of microdrills applied in the destructive web thickness measuring system of microdrills in FIG. 2A according to an embodiment. The destructive web thickness measuring method of microdrills comprises the following steps.

In Step 302, a dual-axis motion platform module is moved to an origin position.

In Step 304, a sectional position to be inspected of a microdrill is set according to a position parameter.

In Step 306, the microdrill is moved to a first locating position by the dual-axis motion platform module, wherein the first locating position is in a first image capture range of a positioning vision module, and the microdrill does not contact with a grinding wheel of a drill grinding module.

In Step 308, a first image is captured by the positioning vision module.

In Step 310, a positioning procedure is performed according to the first image to obtain a first distance between the microdrill and a grinding wheel end surface of the drill grinding module.

In Step 312, a grinding procedure is performed according to the first distance and the sectional position to be inspected, so that the grinding wheel of drill grinding module grinds the microdrill to the sectional position to be inspected.

In Step 314, the microdrill is moved to an image measuring position by the dual-axis motion platform module, wherein the image measuring position is in a second image capture range of a web thickness measuring vision module.

In Step 316, a second image is captured by the web thickness measuring vision module.

In Step 318, an image computing procedure is performed according to the second image to obtain a web thickness value of the microdrill at the sectional position to be inspected.

It should be noted that, before or after Step 302 is performed, a user may put the microdrill 50 to be held by the drill fixture 210 to measure the web thickness value. The origin position described in Step 302 is an initial position of the dual-axis motion platform module 202 established by the user, which may be, but not limited to, the position where the microdrill 50 can be easily installed on the drill fixture 210, and the practical origin position may be adjusted according to practical requirements. The position parameter described in Step 304 is a parameter input to a computer device 201 by the user by a human-machine interface 260. In this embodiment, one position parameter may exist, but the number thereof is not limited to one, that is to say, multiple position parameters may exist, and a case of the multiple position parameters is described hereinafter.

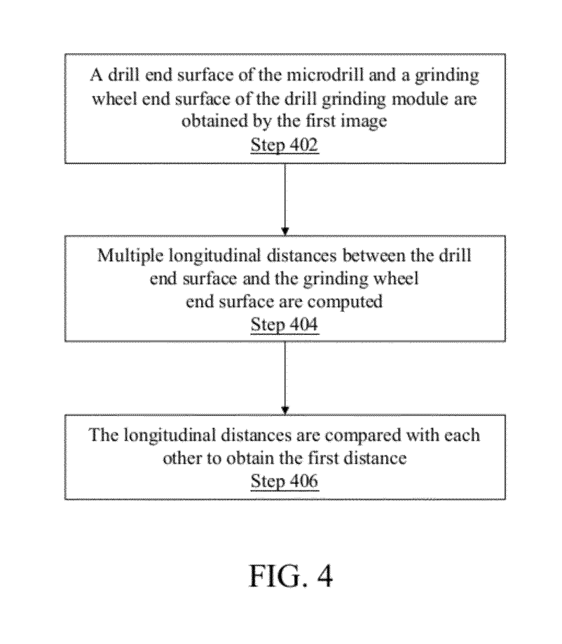

In Step 306, the computer device 201 controls the movements of a longitudinal motion unit 212 and a transversal motion unit 214 by using a motion control submodule 258, so as to adjust the microdrill 50 to the first locating position. In Step 308, the computer device 201 captures the first image by using a first image sensor unit 236 of the positioning vision module 206. FIG. 4 is a schematic flow chart of a positioning procedure in Step 310 according to an embodiment. The positioning procedure may comprise the following steps.

In Step 402, a drill end surface of the microdrill and a grinding wheel end surface of the drill grinding module are obtained by the first image.

In Step 404, multiple longitudinal distances between the drill end surface and the grinding wheel end surface are computed.

In Step 406, the longitudinal distances are compared with each other to obtain the first distance.

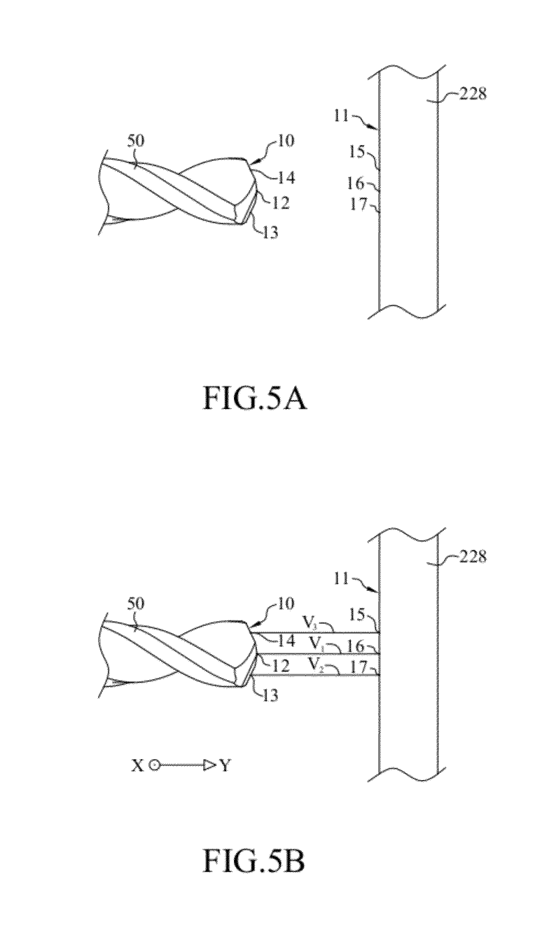

Referring to FIGS. 4 and 5A, FIG. 5A is a schematic view of a first image in Step 308 according to an embodiment of the present invention. The first image comprises a drill end surface 10 and a grinding wheel end surface 11. The drill end surface 10 may be an end surface of a drill point 60 of a microdrill 50 that is not ground, or an end surface of a ground-off sectional position of the microdrill 50. More specifically, when the microdrill 50 is not moved to a first locating position, only the grinding wheel end surface 11 of a grinding wheel 228 is located between a first light source 230 and a first lens 232. When the microdrill 50 is moved to the first locating position, the microdrill 50 and the grinding wheel end surface 11 of the grinding wheel 228 are both located between the first light source 230 and the first lens 232, so that the first light 80 emitted by the first light source 230 reaches the first lens 232 after illuminating the microdrill 50 and the end surface of the grinding wheel 228, and then forms the first image on a first image sensor unit 236, thereby enabling the first image to have edge contour features of the microdrill 50 and the end surface of the grinding wheel 228. The above imaging manner is based on the backlighting illumination.

Referring to FIGS. 4 and 5B, FIG. 5B is a schematic structural view in Step 404 according to an embodiment of the present invention. In Step 404, the longitudinal distances (that is, V₁, V₂, and V₃) are horizontal image distances between the drill end surface 10 and the grinding wheel end surface 11, that is, the direction of the longitudinal distances V₁, V₂, and V₃ is parallel to a longitudinal direction Y, wherein a unit of the longitudinal distance is in pixel. For example, the drill end surface 10 comprises three first end points 12, 13, and 14, and the grinding wheel end surface 11 comprises three second end points 15, 16, and 17. The longitudinal distance V₁ exists between the first end point 12 and the second end point 16. The longitudinal distance V₂ exists between the first end point 13 and the second end point 17. The longitudinal distance V₃ exists between the first end point 14 and the second end point 15. The direction of the longitudinal distances V₁, V₂ and V₃ is parallel to the longitudinal direction Y. Next, Step 406 is performed to compare values of the longitudinal distances V₁, V₂, and V₃. In this embodiment, owing to the dimensional correlation of longitudinal distance V₂>the longitudinal distance V₃>the longitudinal distance V₁, so the longitudinal distance V₁ is the first image distance. Finally, a first scale conversion procedure is performed to convert the first image distance V₁ into a first distance V₁′ (the unit thereof is a practical physical quantity of length), wherein the first scale conversion procedure is described later.

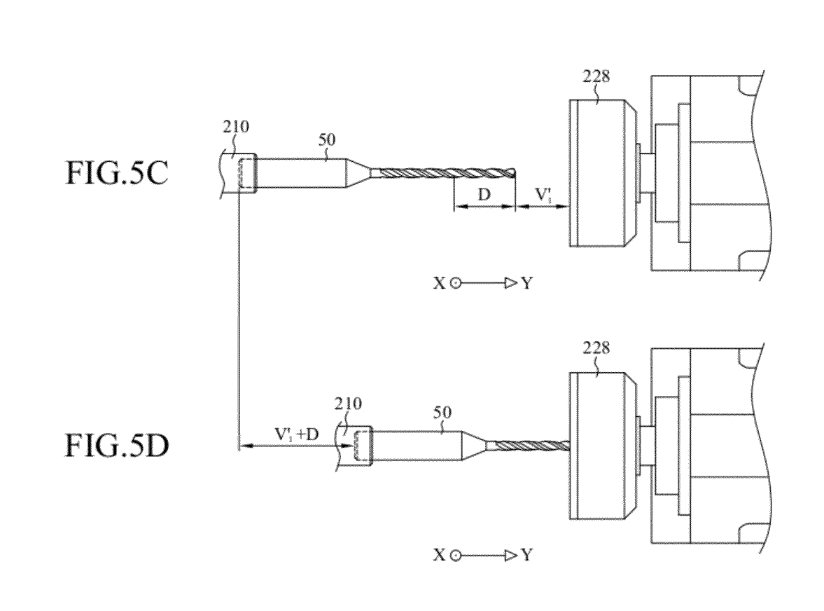

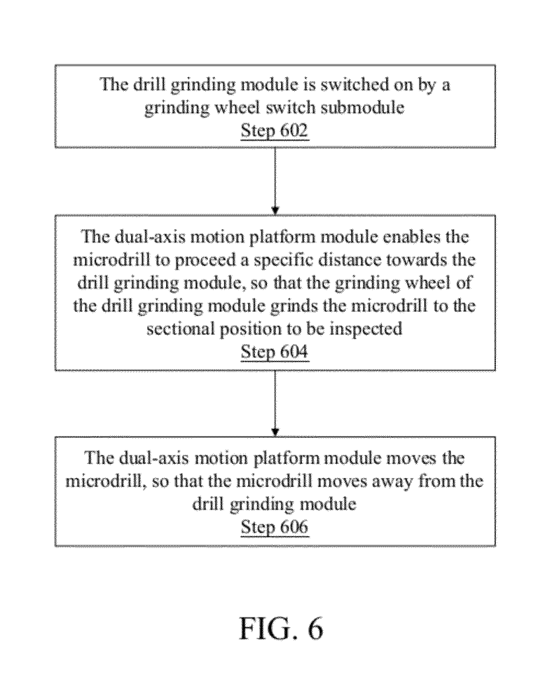

Referring to FIGS. 2A and 6, FIG. 6 is a schematic flow chart of a grinding procedure in Step 312 according to an embodiment. The grinding procedure comprises the following steps.

In Step 602, the drill grinding module is switched on by a grinding wheel switch submodule.

In Step 604, the dual-axis motion platform module enables the microdrill to proceed a specific distance towards the drill grinding module, so that the grinding wheel of the drill grinding module grinds the microdrill to the sectional position to be inspected, wherein the specific distance is relevant to a position parameter and the first distance.

In Step 606, the dual-axis motion platform module moves the microdrill, so that the microdrill moves away from the drill grinding module.

The specific distance in Step 604 is a sum of a distance between the sectional position to be inspected D and a drill tip 60a (referring to FIG. 1A) and the first distance V′₁ (referring to FIG. 5C, which is a schematic structural view of a microdrill being moved to a first locating position according to an embodiment of the present invention). When the microdrill 50 is ground to the sectional position to be inspected D by the grinding wheel 228 of the drill grinding module 204 (referring to FIG. 5D, which is a schematic structural view of a grinding wheel grinding a microdrill to a sectional position to be inspected according to the present invention), the microdrill 50 can be moved away from the drill grinding module 204 by the movement of the dual-axis motion platform module 202 (Step 606). However, this embodiment is not intended to limit the present invention, that is to say, when the microdrill 50 is ground to the sectional position to be inspected D by the grinding wheel 228 of the drill grinding module 204, the drill grinding module 204 may be switched off by the grinding wheel switch submodule 248, so that the grinding wheel 228 stops grinding the microdrill 50.

Next, the motion control submodule 258 may control the dual-axis motion platform module 202 to move the microdrill 50 to the image measuring position (Step 314), so that a second image sensor unit 244 of the web thickness measuring vision module 208 captures the second image (Step 316), wherein the second image comprises an axial section 57 of the microdrill 50 and a background 59 (referring to FIG. 7A, which is a schematic view of a second image in Step 316 according to an embodiment of the present invention).

More specifically, when being moved to the image measuring position, the microdrill 50 is in front of a light gathering unit 246, so the reflected light formed when a second light 82 emitted by the second light source 238 illuminating an axial section to be inspected of the microdrill 50 passes through the second lens 240 and then is received by a second image sensor unit 244 which outputs the second image, such that the second image has an axial section image of the microdrill 50. The above imaging manner is based on the frontlighting illumination.

Referring to FIGS. 7B to 7I, which is a schematic flow chart of an image computing procedure in Step 318 according to an embodiment. In FIG. 7B, the computer device 201 adjusts brightness, contrast, and gamma of the second image by using a central processing module 256. Next, a thresholding operation is performed, so that the background 59 may be, but not limited to, black, and the axial section 57 may be, but not limited to, white, so as to completely separate the axial section 57 from the background 59 (referring to FIG. 7C). As slight errors usually occur during the thresholding operation, a morphological operation is performed to eliminate noises (white spots) in the background 59 and compensate holes (black spots) in the axial section 57 (referring to FIG. 7D).

The computer device 201 performs a calculating procedure according to the axial section 57 by using the central processing module 256 to obtain a centroid 93 of the axial section 57 (referring to FIG. 7E).

The following FIGS. 7F to 7I are schematic views of each process in an imaging computing procedure. Operations actually relevant to FIGS. 7F to 7I are performed in a data manner, and are not performed in an image manner. Therefore, FIGS. 7F to 7I merely provide references for corresponding processes.

Next, referring to FIG. 7F, an edge detection procedure is performed to obtain multiple edge contour points, and these edge contour points can encircle dashed edges in FIG. 7F, wherein an edge detection procedure may be, but not limited to, using the Robert operator to obtain the multiple edge contour points.

The computer device 201 computes the first relative distance between each edge contour point (that is, a₁, a₄, a₅, b₁, b₄, and b₅) and the centroid 93 (referring to FIG. 7G), and compares the first relative distances with each other to select the corresponding edge contour points having the first relative distances smaller than a specific value, so as to obtain a first flute contour area and a second flute contour area, wherein the first flute contour area and the second flute contour area are respectively curve segments formed by the first edge contour points a₁, a₂, and a₃ and the second edge contour points b₁, b₂, and b₃. The specific value may be, but not limited to, 1.2 times of a minimum first relative distance among all the first relative distances. Next, second relative distances between each first edge contour point a₁, a₂, and a₃ comprised in the first flute contour area and each second edge contour point b₁, b₂, and b₃ comprised in the second flute contour area are computed (referring to FIG. 7I). Next, the second relative distances are compared with each other, wherein the shortest second relative distance is a web thickness image distance, and a unit of the web thickness image distance is in pixel. Finally, a second scale conversion procedure is performed to convert the web thickness image distance into a web thickness value (the unit thereof is practical physical quantity of length), wherein the second scale conversion procedure is described later.

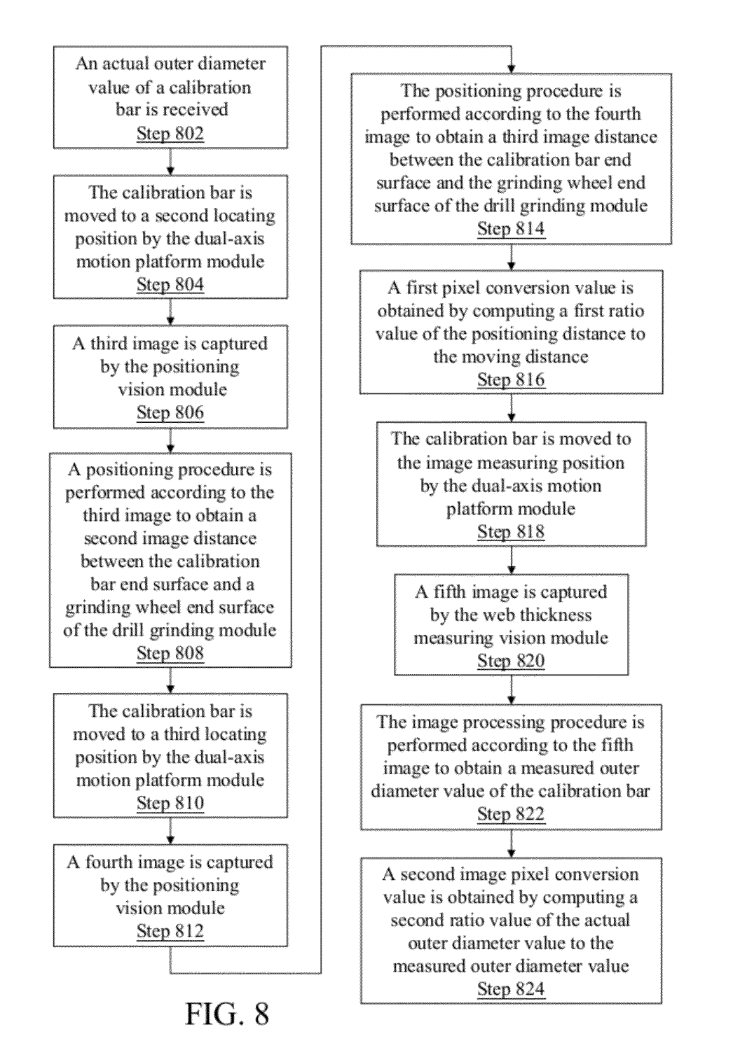

FIG. 8 is a flow chart of steps of an image calibration procedure before Step 304 in FIG. 3 according to an embodiment. The image calibration procedure comprises the following steps.

In Step 802, an actual outer diameter value of a calibration bar is received, in which the calibration bar is a circular bar with a known actual outer diameter value.

In Step 804, the calibration bar is moved to a second locating position by the dual-axis motion platform module, wherein the second locating position is in the first image capture range and the calibration bar does not contact with the grinding wheel of the drill grinding module.

In Step 806, a third image is captured by the positioning vision module.

In Step 808, a positioning procedure is performed according to the third image to obtain a second image distance between the calibration bar end surface and a grinding wheel end surface of the drill grinding module, wherein a unit of the second image distance is in pixel.

In Step 810, the calibration bar is moved to a third locating position by the dual-axis motion platform module, wherein the third locating position is in the first image capture range and the calibration bar does not contact with the grinding wheel of the drill grinding module, a positioning distance exists between the second locating position and the third locating position, the positioning distance may be detected by a first linear encoder, and a unit of the positioning distance is in practical physical quantity of length.

In Step 812, a fourth image is captured by the positioning vision module.

In Step 814, the positioning procedure is performed according to the fourth image to obtain a third image distance between the calibration bar end surface and the grinding wheel end surface of the drill grinding module, wherein a moving distance being the difference between the second image distance and the third image distance exists and a unit of the moving distance is in pixel.

In Step 816, a first pixel conversion value is obtained by computing a first ratio value of the positioning distance to the moving distance.

In Step 818, the calibration bar is moved to the image measuring position by the dual-axis motion platform module.

In Step 820, a fifth image is captured by the web thickness measuring vision module.

In Step 822, the image processing procedure is performed according to the fifth image to obtain a measured outer diameter value of the calibration bar, wherein a unit of the measured outer diameter value is in pixel.

In Step 824, a second pixel conversion value is obtained by computing a second ratio value of the actual outer diameter value to the measured outer diameter value.

In an image calibration procedure, a drill fixture 210 is used for holding the calibration bar (not shown), wherein the calibration bar may be, but not limited to, a standard microdrill where a drill body is not fluted, geometric features of a drill point are not formed, and the actual outer diameter value is known. The second image distance in Step 808 is an image pixel distance between an end surface of the calibration bar and the grinding wheel end surface 11 of the drill grinding module 204 in the third image. The positioning distance in Step 810 is a practical moving distance of the dual-axis motion platform module 202 from the second locating position to the third locating position, and can be detected by the first linear encoder 272. The third image distance in Step 814 is other image pixel distance between the end surface of the calibration bar and the grinding wheel end surface 11 of the drill grinding module 204 in the fourth image, and the moving distance is a resultant image pixel distance of the calibration bar indicating its relative movement between the third image and the fourth image captured by the positioning vision module 206. The first pixel conversion value obtained in Step 816 is a scale of the first image sensor unit 236. In the first scale conversion procedure of the embodiment, the first distance is obtained by a product of the first pixel conversion value and the first image pixel distance. The scale of the second image sensor unit 244 (that is, the second pixel conversion value) can be obtained by the ratio value of the actual outer diameter value received in Step 802 to the measured outer diameter value obtained in Step 822. In Step 822, the image processing procedure may be, but not limited to, finding the edge contour points of the end surface of the calibration bar on the fifth image after performing steps similar to those in FIG. 7A to 7F and then computing the measured outer diameter value by using a least-squares circle-fitting approach. In the second scale conversion procedure of the embodiment, the web thickness value is obtained by the product of the second pixel conversion value and the web thickness image distance.

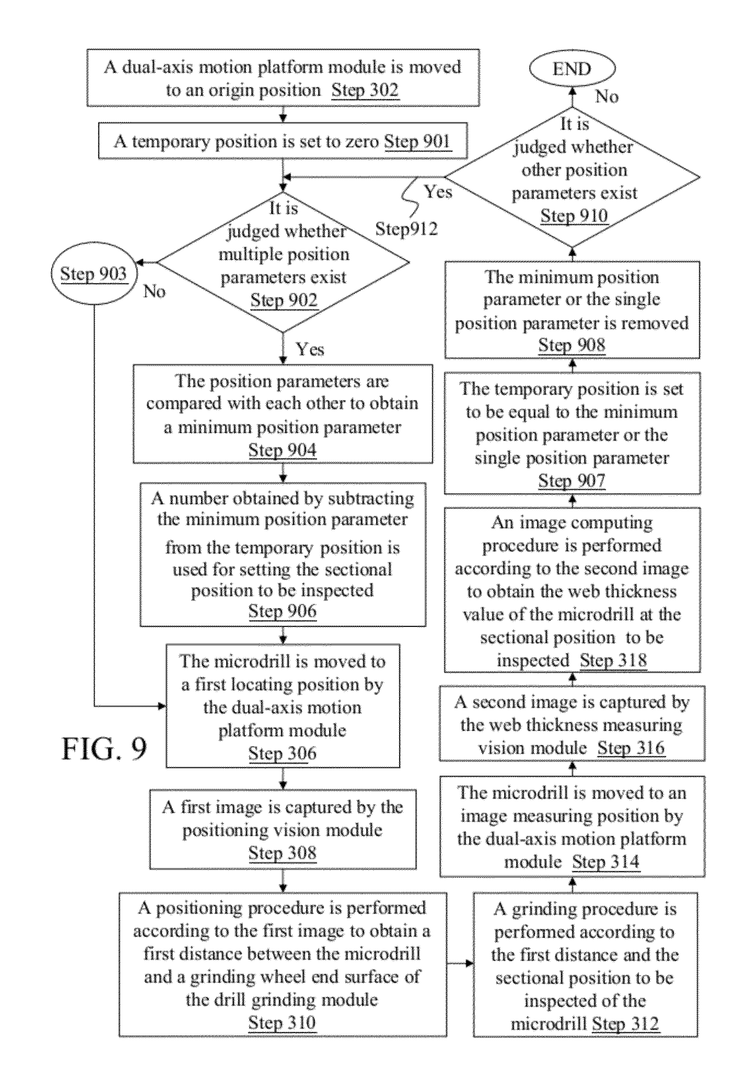

In addition, FIG. 9 is a schematic flow chart of a destructive web thickness measuring method of microdrills applied in a destructive web thickness measuring system of microdrills in FIG. 2A according to another embodiment. In this embodiment, multiple position parameters exist. In addition to the process in the embodiment in FIG. 3, Step 304 of the destructive web thickness measuring method of microdrills comprises the following steps.

In Step 901, a temporary position is set to zero.

In Step 902, it is judged whether multiple position parameters exist.

In Step 903, when only single position parameter exists, a number obtained by subtracting the temporary position from the single position parameter is used for setting the sectional position to be inspected.

In Step 904, when multiple position parameters exist, the position parameters are compared with each other to obtain a minimum position parameter.

In Step 906, a number obtained by subtracting the minimum position parameter from the temporary position is used for setting the sectional position to be inspected.

In addition, after Step 318 is performed, the method further comprises the following steps.

In Step 907, the temporary position is set to be equal to the minimum position parameter or the single position parameter.

In Step 908, the minimum position parameter or the single position parameter is removed.

In Step 910, it is judged whether other position parameters exist.

In Step 912, if other position parameters exist, Step 902 is performed.

In this embodiment, the web thickness value 62 of the microdrill 50 at different sectional positions to be inspected can be measured automatically by performing the above steps. When no more position parameter exists, the destructive web thickness measuring method of microdrills is ended.

The following shows practical experimental results based on a prototype developed according to the above embodiment. Referring to Table 1, in this experiment, the measurement for the web thickness value of three different microdrills A, B, and C was repeatedly performed 10 times. For each microdrill, whose web thickness values were measured at the same sectional position to be inspected but with different placement angles (that is, an angular position of the axial section 57 in a second image changes) by using the destructive measuring system for the web thickness value of the microdrill and the method thereof according to the present invention.

TABLE 1

| | | Type of microdrill | | |
|---|---|---|---|---|
| | | A | B | C |
| Web thickness value | #1 | 0.1175 | 0.1292 | 0.1488 |
| (mm) | #2 | 0.1176 | 0.1293 | 0.1481 |
| | #3 | 0.1176 | 0.1289 | 0.1483 |
| | #4 | 0.1165 | 0.1285 | 0.1490 |
| | #5 | 0.1166 | 0.1298 | 0.1487 |
| | #6 | 0.1174 | 0.1294 | 0.1482 |
| | #7 | 0.1175 | 0.1292 | 0.1484 |
| | #8 | 0.1173 | 0.1290 | 0.1487 |
| | #9 | 0.1173 | 0.1293 | 0.1485 |
| | #10 | 0.1172 | 0.1295 | 0.1480 |
| | Mean value | 0.1173 | 0.1292 | 0.1485 |
| | Repeatability | ±0.0012 | ±0.0012 | ±0.0009 |

It can be seen from Table 1 that, the repeatability of the destructive web thickness measuring system of microdrills and the method thereof according to the present invention was within the range of ±0.002 millimeter (±2 micron). The repeatability is defined by ±3 times of a standard deviation of the 10 measured data.

In addition, the web thickness values of the three different microdrills A, B, and C at four different sectional positions to be inspected were measured by using the destructive web thickness measuring system of microdrills and the method thereof according to the present invention. In this experiment, apart from the measurement of the web thickness values by using the above destructive web thickness measuring method of microdrills, the web thickness values were also measured by using a manual measuring method (by using a measuring microscope) in the prior art. The measured web thickness values are shown in Table 2, in which, L_{A}, L_{B}, and L_{c} are drill body lengths of the microdrills A, B, and C, respectively.

TABLE 2

| | | Destructive web | | |
|---|---|---|---|---|
| Measuring method | | thickness measuring | A manual | Absolute |
| | Sectional | system of | measuring | value |
| | position | microdrills | method | of the |
| Type of | to be | Web thickness | Web thickness | difference |
| microdrill | inspected | value (mm) | value (mm) | (mm) |
| A | 0.20L_{A} | 0.1173 | 0.1168 | 0.0005 |
| | 0.35L_{A} | 0.1370 | 0.1374 | 0.0004 |
| | 0.50L_{A} | 0.1472 | 0.1461 | 0.0011 |
| | 0.65L_{A} | 0.1590 | 0.1593 | 0.0003 |
| B | 0.20L_{B} | 0.1292 | 0.1266 | 0.0026 |
| | 0.35L_{B} | 0.1590 | 0.1589 | 0.0001 |
| | 0.50L_{B} | 0.1740 | 0.1720 | 0.0020 |
| | 0.65L_{B} | 0.1949 | 0.1923 | 0.0026 |
| C | 0.20L_{C} | 0.1485 | 0.1466 | 0.0019 |
| | 0.35L_{C} | 0.1672 | 0.1659 | 0.0013 |
| | 0.50L_{C} | 0.1879 | 0.1875 | 0.0004 |
| | 0.65L_{C} | 0.2040 | 0.2029 | 0.0011 |

It can be seen from Table 2 that, when the sectional position to be inspected was closer to a shank, the web thickness value was greater, and an approximately linearly increasing trend existed. Furthermore, each absolute value of the difference between the measured values based on the destructive measuring method for the web thickness value of the microdrill according to the present invention and the manual measuring method in the prior art was less than 0.003 millimeter (3 micron).

In the destructive web thickness measuring system of microdrills and the destructive web thickness measuring method of microdrills according to the present invention, the web thickness value of the microdrill at a sectional position to be inspected can be automatically measured by the setting of a computer device. By the design of a positioning vision module, it can be effective to ensure whether the drill grinding module grinds the microdrill to the sectional position to be inspected in the positioning procedure and the grinding procedure. By the design of a web thickness measuring vision module and an image computing procedure, the measuring stability of the destructive web thickness measuring system of microdrills according to the present invention can be improved. It can be seen from the experimental results that, measuring repeatability of the destructive web thickness measuring system of microdrills according to the present invention was within the range of ±2 micron, and the absolute value of the difference between the measured values based on the destructive web thickness measuring method of microdrills according to the present invention and the manual measuring method in the prior art was less than 3 micron. By the setting of the computer device, the process of the destructive web thickness measurement of microdrills can be effectively controlled.

What is claimed is:

1. A destructive web thickness measuring system of microdrills for measuring a web thickness value of a microdrill, comprising:
a computer device;
a dual-axis motion platform module, coupled to the computer device, and used for holding the microdrill, wherein the computer device controls the dual-axis motion platform module to enable the microdrill to move;
a drill grinding module, for grinding the microdrill to a sectional position to be inspected when the computer device controls the dual-axis motion platform module to move the microdrill to a grinding position;
a positioning vision module, for capturing and outputting a first image to the computer device when the computer device controls the dual-axis motion platform module to move the microdrill to a first locating position, wherein the computer device performs a positioning procedure according to the first image to obtain a first distance between the microdrill and the drill grinding module, and the computer device controls the drill grinding module according to the first distance and the sectional position to be inspected, so that the drill grinding module grinds the microdrill to the sectional position to be inspected, the first locating position is in a first image capture range of the positioning vision module, and the microdrill does not contact with the drill grinding module; and
a web thickness measuring vision module, for capturing and outputting a second image to the computer device when the computer device controls the dual-axis motion platform module to move the microdrill to an image measuring position, wherein the computer device performs an image computing procedure according to the second image to obtain the web thickness value of the microdrill at the sectional position to be inspected, and the image measuring position is in a second image capture range of the web thickness measuring vision module.

2. The destructive web thickness measuring system of microdrills according to claim 1, wherein the dual-axis motion platform module comprises a drill fixture, a longitudinal motion unit, and a transversal motion unit, the drill fixture is used for holding the microdrill, the longitudinal motion unit enables the drill fixture to move along a longitudinal direction, the transversal motion unit enables the drill fixture to move along a transversal direction, and the longitudinal direction and the transversal direction are perpendicular to each other.

3. The destructive web thickness measuring system of microdrills according to claim 1, wherein the drill grinding module comprises an induction motor, a transmission unit, and a grinding wheel, the computer device controls the induction motor and enables the induction motor to drive the grinding wheel to rotate by the transmission unit, so as to grind the microdrill to the sectional position to be inspected.

4. The destructive web thickness measuring system of microdrills according to claim 1, wherein the positioning vision module comprises a first light source, a first lens, and a first image sensor unit, the first light source emits a first light, an emitting direction of the first light and a first axial direction of the first lens are actually parallel to a transversal direction respectively, and when the dual-axis motion platform module moves the microdrill to the first locating position, the first image sensor unit receives the first light passing through the first lens and outputs the first image to the computer device.

5. The destructive web thickness measuring system of microdrills according to claim 1, wherein the web thickness measuring vision module comprises a second light source, a second lens, and a second image sensor unit, the second light source emits a second light, when the dual-axis motion platform module moves the microdrill to the image measuring position, the second light illuminates an axial section of the sectional position to be inspected of the microdrill, and a reflected light formed when the second light illuminates the axial section passes through the second lens and is received by the second image sensor unit, the second image sensor unit outputs the second image to the computer device according to the reflected light, and a second axial direction of the second lens is parallel to a central axis of the microdrill.

6. The destructive web thickness measuring system of microdrills according to claim 5, wherein the web thickness measuring vision module further comprises a light gathering unit, and the light gathering unit enables the second light to actually converge at the image measuring position.

7. A destructive web thickness measuring method of microdrills, comprising:
moving a dual-axis motion platform module to an origin position;
setting a sectional position to be inspected of the microdrill according to a position parameter;
moving the microdrill to a first locating position by the dual-axis motion platform module, wherein the first locating position is in a first image capture range of a positioning vision module, and the microdrill does not contact with a drill grinding module;
capturing a first image by the positioning vision module;
performing a positioning procedure according to the first image to obtain a first distance between the microdrill and the drill grinding module;
performing a grinding procedure according to the first distance and the sectional position to be inspected, so that the drill grinding module grinds the microdrill to the sectional position to be inspected;
moving the microdrill to an image measuring position by the dual-axis motion platform module, wherein the image measuring position is in a second image capture range of a web thickness measuring vision module;
capturing a second image by the web thickness measuring vision module; and
performing an image computing procedure according to the second image to obtain a web thickness value of the microdrill at the sectional position to be inspected.

8. The destructive web thickness measuring method of microdrills according to claim 7, wherein the positioning procedure comprises:
obtaining a drill end surface of the microdrill and a grinding wheel end surface of the drill grinding module by the first image;
computing multiple longitudinal distances between the drill end surface and the grinding wheel end surface; and
comparing the longitudinal distances to obtain the first distance.

9. The destructive web thickness measuring method of microdrills according to claim 7, wherein the grinding procedure comprises:
switching on the drill grinding module by a grinding wheel switch submodule;
moving the microdrill to proceed a specific distance towards the drill grinding module by the dual-axis motion platform module, so that the drill grinding module grinds the microdrill to the sectional position to be inspected, wherein the specific distance is relevant to the position parameter and the first distance; and
moving the microdrill by the dual-axis motion platform module, so that the microdrill moves away from the drill grinding module.

10. The destructive web thickness measuring method of microdrills according to claim 7, wherein the image computing procedure comprises:
adjusting brightness, contrast, and gamma of the second image, wherein the second image comprises an axial section of the microdrill and a background;
performing a thresholding operation, so as to completely separate the axial section from the background;
performing a morphological operation, so as to eliminate at least one noise in the background and compensate at least one hole in the axial section;
performing a calculating procedure according to the axial section to obtain a centroid of the axial section;
performing an edge detection procedure to obtain multiple edge contour points;
computing a first relative distance between each edge contour point and the centroid;
comparing the first relative distances to obtain a first flute contour area and a second flute contour area;
computing a second relative distance between each edge contour point comprised in the first flute contour area and each edge contour point comprised in the second flute contour area;
comparing the second relative distances to obtain a web thickness image distance; and
performing a scale conversion procedure to convert the web thickness image distance into the web thickness value.

11. The destructive web thickness measuring method of microdrills according to claim 7, wherein before the step of setting the sectional position to be inspected of the microdrill by the position parameter, an image calibration procedure is performed, and the image calibration procedure comprises:
receiving an actual outer diameter value of a calibration bar;
moving the calibration bar to a second locating position by the dual-axis motion platform module, wherein the second locating position is in the first image capture range and the calibration bar does not contact with the drill grinding module;
capturing a third image by the positioning vision module;
performing the positioning procedure according to the third image to obtain a second image distance between the calibration bar and the drill grinding module;
moving the calibration bar to a third locating position by the dual-axis motion platform module, wherein the third locating position is in the first image capture range and the calibration bar does not contact with the drill grinding module, and a positioning distance exists between the second locating position and the third locating position;
capturing a fourth image by the positioning vision module;
performing the positioning procedure according to the fourth image to obtain a third image distance between the calibration bar and the drill grinding module, wherein a moving distance being the difference between the second image distance and the third image distance exists;
computing a first ratio value of the positioning distance to the moving distance to obtain a first pixel conversion value;
moving the calibration bar to the image measuring position by the dual-axis motion platform module;
capturing a fifth image by the web thickness measuring vision module;
performing an image processing procedure according to the fifth image to obtain a measured outer diameter value; and
computing a second ratio value of the measured outer diameter value to the actual outer diameter value to obtain a second pixel conversion value.

12. The destructive web thickness measuring method of microdrills according to claim 7, wherein the step of setting the sectional position to be inspected of the microdrill with the position parameter comprises:
setting a temporary position to zero;
judging whether multiple position parameters exist;
when only single position parameter exists, using a number obtained by subtracting the temporary position from the single position parameter to set the sectional position to be inspected;
when multiple position parameters exist, comparing the position parameters to obtain a minimum position parameter; and
using a number obtained by subtracting the minimum position parameter from the temporary position to set the sectional position to be inspected.

13. The destructive web thickness measuring method of microdrills according to claim 12, after the step of performing the image computing procedure according to the second image to obtain the web thickness value of the microdrill at the sectional position to be inspected, further comprising:
setting the temporary position to be equal to the minimum position parameter or the single position parameter;
removing the minimum position parameter or the single position parameter;
judging whether other position parameters exist; and
performing the step of judging whether the multiple position parameters exist when other position parameters exist.
